(19) United States
(12) Patent Application Publication
(10) Pub. No.: US 2016/0345735 A1
(43) Pub. Date: Dec. 1, 2016

(54) SUPPORT FOR DEVICE TO BE HANG

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: CHUN-LEI SHI, Shenzhen (CN); KUO-CHUAN LING, New Taipei (TW); LUNG-HSING LEE, New Taipei (TW); JEN-HUI OH, New Taipei (TW); WEN-PIN WANG, New Taipei (TW); FANG-YUAN SHYU, New Taipei (TW)

(21) Appl. No.: 14/882,950

(22) Filed: Oct. 14, 2015

(30) Foreign Application Priority Data
May 29, 2015 (CN) 201510285250.9

(51) Int. Cl. A47B 97/00; F16M 13/02

(52) U.S. Cl. CPC A47B 97/001; F16M 13/02

(57) ABSTRACT

A hanging support for hanging a panel display on a flat surface includes a mounting structure and a support structure. The support structure fixes the panel display on the mounting structure. The mounting structure is mounted on the flat surface and adjusts an angle between the panel display and the flat surface. The support structure includes a top holder, a bottom holder, and a main holder. The top holder, the bottom holder, and the main holder corporately define a clamping space to clamp two opposite edges of the display panel.

### CROSS-REFERENCE TO RELATED APPLICATIONS

This application claims priority to Chinese Patent Application No. 201510285250.9 filed on May 29, 2015, the contents of which are incorporated by reference herein.

### FIELD

The subject matter herein generally relates to device supports.

### BACKGROUND

Typically, panel displays, such as television (TV), are hung on a wall surface with a use of screws or other conventional means. Mounting holes are defined in the panel display.

### BRIEF DESCRIPTION OF THE DRAWINGS

Implementations of the present technology will now be described, by way of example only, with reference to the attached figures.

FIG. 1 is a perspective view of an embodiment of a hanging support for a panel display.

FIG. 2 is a side view of the hanging support for the panel display in FIG. 1.

FIG. 3 is an exploded, perspective view of the hanging support for the panel display of FIG. 1.

FIG. 4 is a schematic view illustrating assembly of a top holder and a bottom holder of the hanging support for the panel display of FIG. 1.

FIG. 5 is a schematic view illustrating assembly of a main holder of the hanging support for the panel display based on FIG. 4.

FIG. 6 is a schematic view illustrating assembly of bridging portions of the hanging support for the panel display based on FIG. 5.

FIG. 7 is a schematic view illustrating assembly of an angle control portion and a bracket portion of the hanging support for the panel display based on FIG. 6.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a hanging support 100 for a panel display 200.

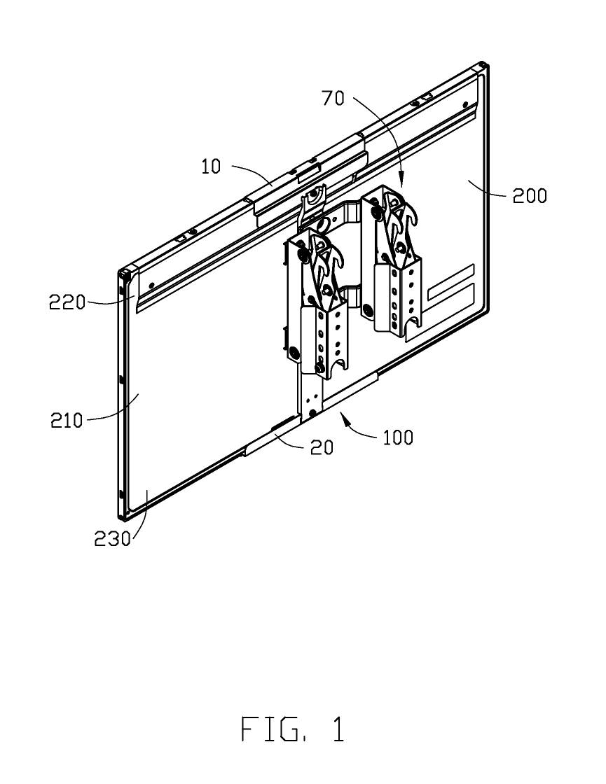

FIG. 1 illustrates an embodiment of the hanging support 100 for the panel display 200.

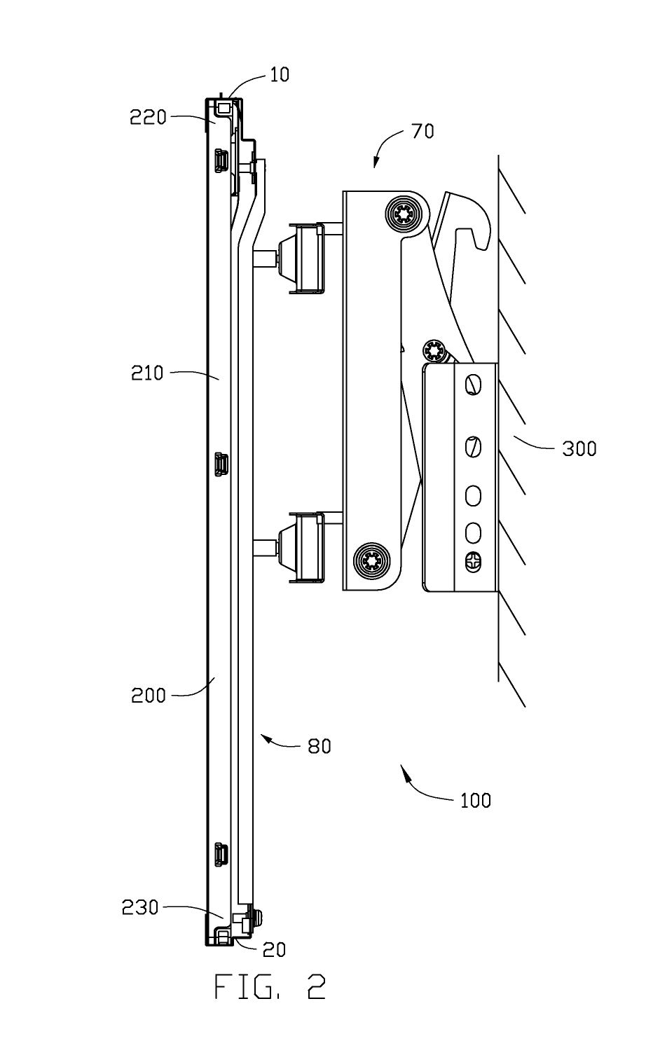

FIG. 2 illustrates the hanging support 100 of FIG. 1 used to fix the panel display 200 on a flat surface 300, such as a wall. The panel display 200 can comprise an outer shell 210 and a display module (not shown) housed in the outer shell 210. The outer shell 210 can comprise a top edge 220 and a bottom edge 230 disposed opposite the top edge 220.

The hanging support 100 can comprise a mounting structure 70 and a support structure 80. The support structure 80 is configured to fix the panel display 200 with the mounting structure 70. The mounting structure 70 is mounted on the flat surface 300 and is configured to adjust an angle between the panel display 200 and the flat surface 300.

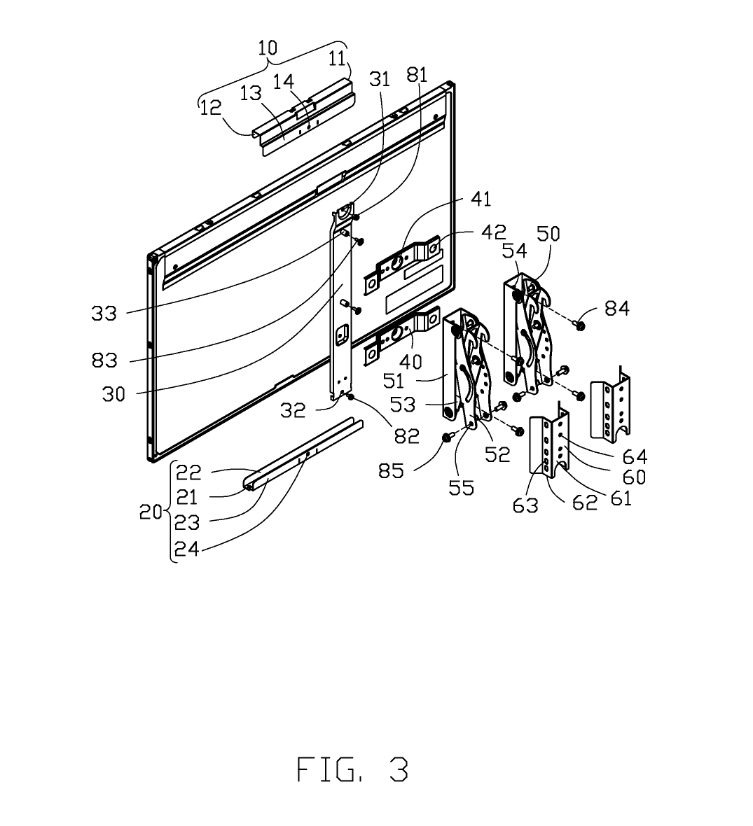

FIG. 3 illustrates the hanging support 100 for the panel display 200. The support structure 80 can comprise a top holder 10, a bottom holder 20, and a main holder 30. The mounting structure 70 can comprise a bridging portion 40, an angle control portion 50, and a bracket portion 60.

The main holder 30 is fixed on a back surface of the outer shell 210. Opposite ends of the main holder 30 couple the top holder 10 and the bottom holder 20. The top holder 10, the bottom holder 20, and the main holder 30 corporately define a clamping space to clamp two opposite edges of the display panel 200. In at least one embodiment, the top holder 10 and the bottom holder 20 are respectively positioned on the top edge 220 and the bottom edge 230.

The top holder 10 can comprise a first end wall 11, a first outer wall 12, and a first inner wall 13. The first end wall 11, the first outer wall 12, and the first inner wall 13 form a space for receiving the top edge 220. The bottom holder 20 can comprise a second end wall 21, a second outer wall 22, and a second inner wall 23. The second end wall 21, the second outer wall 22, and the second inner wall 23 form a space for receiving the bottom edge 230. The first end wall 11 is substantially parallel with the second end wall 21. The first end wall 11 and second end wall 21 resist the top edge 220 and the bottom edge 230 respectively. The first inner wall 13 is a substantially stepped shape for fitting the back surface of the outer shell 210, and the second inner wall 23 is a substantially stepped shape for fitting the back surface of the outer shell 210.

A first connection hole 14 is defined in the first inner wall 13 of the top holder 10. A second connection hole 24 is defined in the second inner wall 23 of the bottom holder 20. A third connection hole 31 corresponding to the first connection hole 14 is defined in the end of the main holder 30 which is coupled to the top holder 10. A fourth connection hole 32 corresponding to the second connection hole 24 is defined in the opposite end of the main holder 30 which is coupled to the bottom holder 20. The hanging support 100 further comprises a first screw 81 and a second screw 82. The first screw 81 is inserted into the third connection hole 31 and the first connection hole 14 for fixing the end of the main holder 30 on the top holder 10. The second screw 82 is inserted into the fourth connection hole 32 and the second connection hole 24 for fixing the opposite end of the main holder 30 with the bottom holder 20. I-shaped structure is formed by the connected top holder 10, bottom holder 20, and the main holder 30.

The angle control portion 50 and the bracket portion 60 are coupled to the main holder 30 through the bridging portion 40. The main holder 30 can comprise two poles 33 protruding out from the main holder 30 away from the outer shell 210. The pole 33 is substantially hollow cylinder shaped. In at least one embodiment, the hanging support 100 comprises two bridging portions 40. Fifth connection holes 41 corresponding to the poles 33 are defined in the bridging portions 40. The hanging support 100 further comprises third screws 83 fitted in the poles 33. The third screws 83 are inserted into and screwed with the poles 33 by passing the fifth connection holes 41, which causes the bridging portions 40 being fastened to the main holder 30.

The angle control portion 50 can comprise a main body 51, a locating arm 52, and an adjusting arm 53. The locating arm 52 is engaged with the adjusting arm 53 so that a preset angle is defined by the main body 51, the locating arm 52, and the adjusting arm 53 cooperatively, for controlling a tilt angle between the flat surface 300 and the main holder 30. In at least one embodiment, the hanging support 100 comprises two angle control portions 50 and two bracket portions 60 corresponding to the angle control portions 50.

Horizontal lengths of the bridging portions 40 are greater than the vertical lengths of the bridging portions 40. Vertical lengths of the angle control portions 50 are greater than horizontal lengths of the angle control portion 50. Sixth connection holes 42 are defined in two opposite ends of the bridging portion 40 in a horizontal direction. Two seventh connection holes 54 are defined in the main body 51 of each angle control portions 50. The seventh connection holes 54 in each angle control portion 50 are relative to the sixth connection holes 42 of different bridging portions 40 arranged in a line. The hanging support 100 further comprises fourth screws 84 inserting into the sixth connection hole 42 and the seventh connection hole 54, for fastening the angle control portions 50 to the bridging portions 40.

Eighth connection holes 55 are defined in the locating arm 52. Each bracket portion 60 is defined as U-shaped structure. The bracket portion 60 can comprise a locating plane 61, a side wall 62, and ninth connection holes 63 corresponding to the eighth connection holes 55, defined in the side wall 62. The hanging support 100 further comprises fifth screws 85 inserted into the eighth connection holes 55 and the ninth connection holes 63, for fastening the angle control portions 50 to the bracket portions 60. The bracket portion 60 also comprises locating holes 64 defined in the locating plane 61. The locating hole 64 is configured to fasten on the flat surface 300 through a screw.

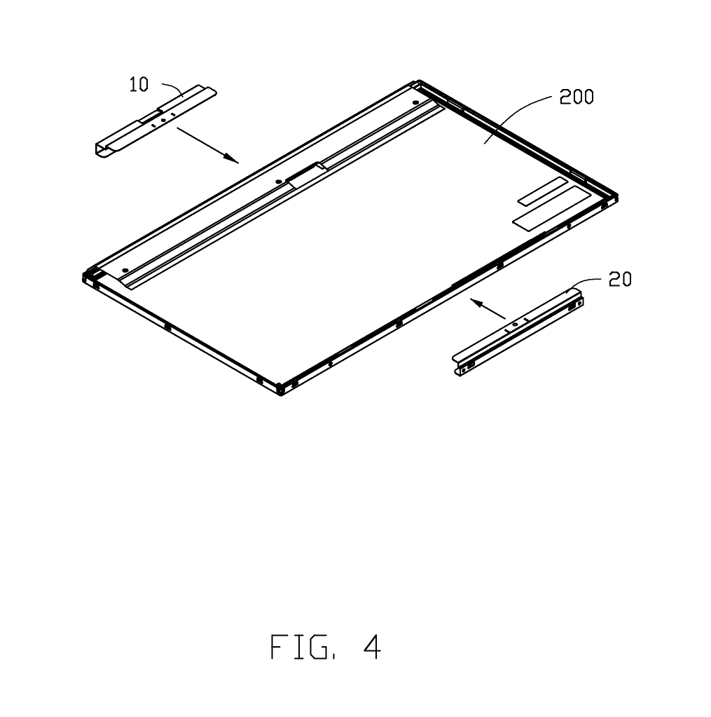

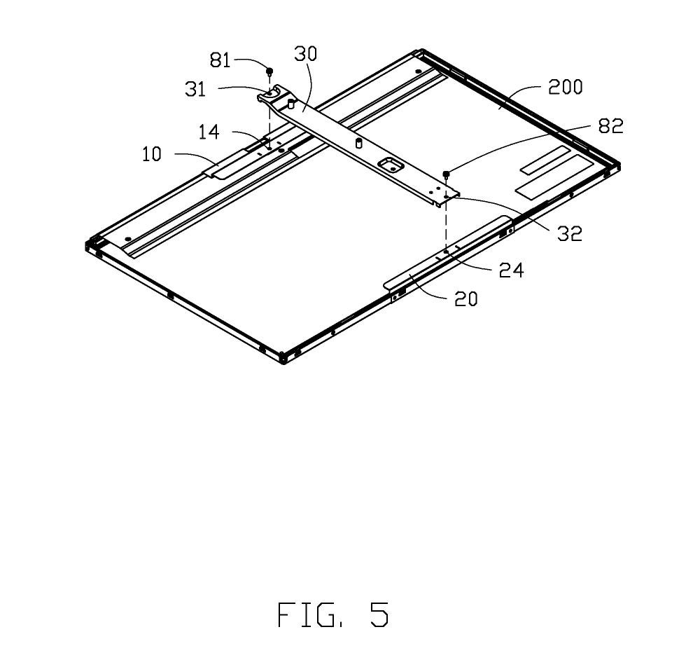

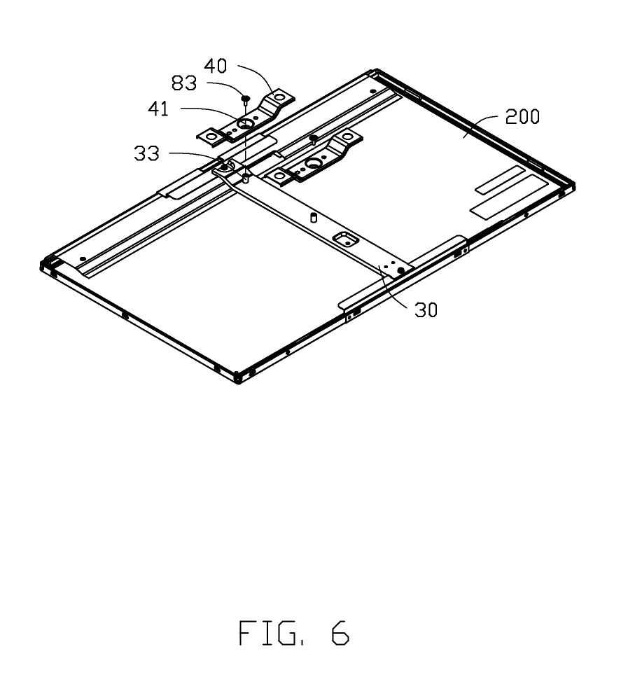

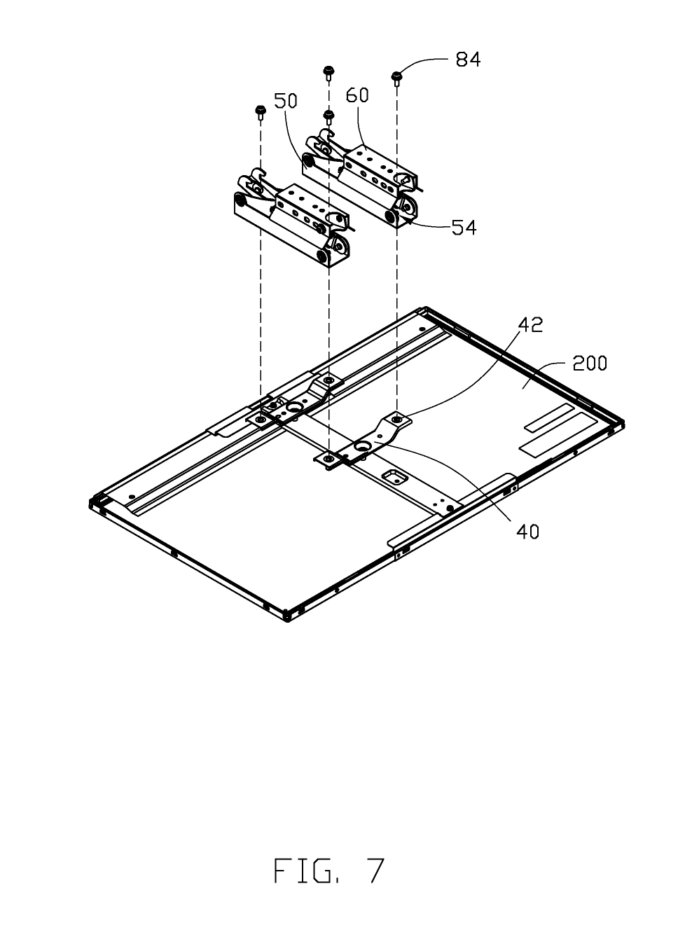

FIG. 4 to FIG. 7 illustrate assembling of the hanging support 100 for the panel display 200. In assembly, the top edge 220 and the bottom edge 230 are secured to the top holder 10 and the bottom holder 20 respectively. The end of the main holder 30 is fixed on the top holder 10 by the first screw 81 passing through the third connection hole 31 and the first connection hole 14. The opposite end of the main holder 30 is fixed on the top holder 10 by the second screw 82 passing through the fourth connection hole 32 and the second connection hole 24. The main holder 30 is assembled together with the top holder 10 and the bottom holder 20. The bridging portions 40 are securely coupled with the main holder 30 by the third screws 83 passing the fifth connection holes 41 screwed with the poles 33. The angle control portion 50 is securely connected with the bracket portions 60, and the angle control portion 50 is mounted on the bridging portions 40 by the fourth screws 84 passing the sixth connection hole 42 and the seventh connection hole 54. The panel display 200 is secured in the hanging support 100, and is fastened on the flat surface 300 through the bracket portion 60 of the hanging support 100.

Based on the structure of the hanging support 100, the top holder 10, the bottom holder 20, and the main holder 30 cooperate with each other for forming a clamping space to clamp two opposite edges of the display panel while hinging the display panel on the flat surface 300.

The embodiment shown and described above is only example. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A hanging support for hanging a panel display on a flat surface, comprising:
a support structure, comprising:
a top holder configured to clamp a top edge of the panel display;
a bottom holder opposite to the top holder, and configured to clamp a bottom edge of the panel display; and
a main holder fixed to a back surface of an outer shell of the panel display, two opposite ends of the main holder coupled to the top holder and the bottom holder respectively; and
a mounting structure configured to fix between the support structure through the main holder and the flat surface, and configured to adjust an angle between the panel display and the flat surface;
wherein the top holder, the bottom holder, and the main holder corporately define a clamping space to clamp two opposite edges of the display panel.

2. The hanging support according to claim 1, wherein the top holder comprises a first end wall, a first outer wall, and a first inner wall opposite to the first outer wall, the bottom holder comprises a second end wall opposite to the first end wall, a second outer wall, and a second inner wall opposite to the second outer wall, the first end wall and the second end wall resist the top edge and the bottom edge of the display panel respectively, the first inner wall is substantially a stepped shape for fitting the back surface of the outer shell, and the second inner wall is substantially a stepped shape for fitting the back surface of the outer shell.

3. The hanging support according to claim 2, wherein a first connection hole is defined in the first inner wall of the top holder, a second connection hole is defined in the second inner wall of the bottom holder, a third connection hole corresponding to the first connection hole is defined in the end of the main holder which is coupled to the top holder, a fourth connection hole corresponding to the second connection hole is defined in the end of the main holder which is coupled to the bottom holder, the hanging support further comprises a first screw and a second screw, the first screw is inserted into the third connection hole and the first connection hole for fixing the end of the main holder on the top holder, and the second screw is inserted into the fourth connection hole and the second connection hole for fixing the opposite end of the main holder with the bottom holder.

4. The hanging support according to claim 3, wherein an I-shaped structure is formed by the connected top holder, bottom holder, and main holder.

5. The hanging support according to claim 1, wherein the mounting structure comprises a bridging portion, the mounting structure is fixed to the main holder through the bridging portion.

6. The hanging support according to claim 5, wherein the main holder comprises two poles protruded out from the main holder away from the outer shell, and the pole is substantially hollow cylinder shaped, the hanging support comprises two bridging portions, fifth connection holes corresponding to the poles are defined in the bridging portions, the hanging support further comprises third screws fitted with in the poles, and the third screws are inserted into and screwed poles by passing the fifth connection holes which causes the bridging portions being fastened to the main holder.

7. The hanging support according to claim 1, wherein the mounting structure further comprises an angle control portion and a bracket portion securely connected with the angle control portion, the angle control portion is configured to adjust the angle between the panel display and the flat surface, the bracket portion is configured to fasten the hanging support on the flat surface.

8. The hanging support according to claim 7, wherein the angle control portion comprises a main body, a locating arm, and an adjusting arm, the locating arm is engaged with the adjusting arm so that a preset angle is defined by the main body, the locating arm, and the adjusting arm cooperatively.

9. The hanging support according to claim 8, wherein horizontal lengths of the bridging portions are greater than the vertical lengths of the bridging portions, sixth connection holes are defined in two ends of the bridging portions in the horizontal direction respectively, two seventh connection holes are defined in the main body of each angle control portion, the seventh connection holes in each angle control portion is relative to two sixth connection holes defined in the same end of the bridging portions, the hanging support further comprises fourth screws fitted in the sixth connection hole and the seventh connection hole, for fastening the angle control portions to the bridging portions.

10. The hanging support according to claim 9, wherein eighth connection holes are defined in the locating arm, each bracket portion is defined as U-shaped structure, the bracket portion comprises a locating plane, a side wall, and ninth connection holes corresponding to the eighth connection holes, defined in the side wall, the hanging support further comprises fifth screws fitted in the eighth connection holes and the ninth connection holes, for fastening the angle control portions to the bracket portions.

11. The hanging support according to claim 8, wherein vertical lengths of the angle control portions are greater than horizontal lengths of the angle control portion.

12. A hanging support for hanging a panel display on a flat surface, comprising:
a support structure defined a clamping space to clamp two opposite edges of the display panel; and
a mounting structure configured to fix between the support structure and the flat surface, the mounting structure comprising:
a bridging portion configured to fix the mounting structure to the support structure;
a angle control portion configured to adjust an angle between the panel display and the flat surface; and
a bracket portion configured to fasten the hanging support on the flat surface;
wherein the angle control portion comprises a main body, a locating arm, and an adjusting arm, the locating arm is engaged with the adjusting arm so that the angle is defined by the main body, the locating arm, and the adjusting arm cooperatively.

13. The hanging support according to claim 12, wherein the support structure comprises a top holder, a bottom holder, and a main holder, the main holder is fixed to a back surface of an outer shell of the panel display, two opposite ends of the main holder coupled to the top holder and the bottom holder respectively.

14. The hanging support according to claim 13, wherein the top holder comprises a first end wall, a first outer wall, and a first inner wall opposite to the first outer wall, the bottom holder comprises a second end wall opposite to the first end wall, a second outer wall, and a second inner wall opposite to the second outer wall, the first end wall and the second end wall resist the top edge and the bottom edge of the display panel respectively, the first inner wall is substantially a stepped shape for fitting the back surface of the outer shell, and the second inner wall is substantially a stepped shape for fitting the back surface of the outer shell.

15. The hanging support according to claim 14, wherein a first connection hole is defined in the first inner wall of the top holder, a second connection hole is defined in the second inner wall of the bottom holder, a third connection hole corresponding to the first connection hole is defined in the end of the main holder which is coupled to the top holder, a fourth connection hole corresponding to the second connection hole is defined in the end of the main holder which is coupled to the bottom holder, the hanging support further comprises a first screw and a second screw, the first screw is inserted into the third connection hole and the first connection hole for fixing the end of the main holder on the top holder, and the second screw is inserted into the fourth connection hole and the second connection hole for fixing the opposite end of the main holder with the bottom holder.

16. The hanging support according to claim 15, wherein an I-shaped structure is formed by the connected top holder, bottom holder, and main holder.

17. The hanging support according to claim 13, wherein the main holder comprises two poles protruded out from main holder away from the outer shell, and the pole is substantially hollow cylinder shaped, the hanging support comprises two bridging portions, fifth connection holes corresponding to the poles are defined in the bridging portions, the hanging support further comprises third screws fitted in the poles, and the third are inserted into and screwed in the poles by passing the fifth connection holes which causes the bridging portions being fastened to the main holder.

18. The hanging support according to claim 17, wherein horizontal lengths of the bridging portions are greater than the vertical lengths of the bridging portions, sixth connection holes are defined in two ends of the bridging portions in the horizontal direction respectively, two seventh connection holes are defined in the main body of each angle control portion, the seventh connection holes in each angle control portion is relative to two sixth connection holes defined in the same end of the bridging portions, the hanging support further comprises fourth screws fitted in the sixth connection hole and the seventh connection hole, for fastening the angle control portions to the bridging portions.

19. The hanging support according to claim 18, wherein vertical lengths of the angle control portions are greater than horizontal lengths of the angle control portion.

20. The hanging support according to claim 19, wherein eighth connection holes are defined in the locating arm, each bracket portion is defined as U-shaped structure, the bracket portion comprises a locating plane, a side wall, and ninth connection holes corresponding to the eighth connection holes, defined in the side wall, the hanging support further comprises fifth screws fitted in the eighth connection holes and the ninth connection holes, for fastening the angle control portions to the bracket portions.
